(19) United States
(12) Patent Application Publication
(10) Pub. No.: US 2008/0037792 A1
(43) Pub. Date: Feb. 14, 2008

(54) HOME NETWORK SYSTEMS

(76) Inventors: David Becker, Newport, CA (US); Chia Lun Chung, Irvine, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/559,778

(22) Filed: Nov. 14, 2006

Related U.S. Application Data
(60) Provisional application No. 60/836,590, filed on Aug. 8, 2006.

(51) Int. Cl. H04L 9/08

(52) U.S. Cl. 380/279

(57) ABSTRACT

A method and system for key management and distribution are disclosed. A network can comprise plurality of stations, each station is dedicated to a network device and is configured to plug into an electrical receptacle so as to facilitate network communications via home electrical wiring for the network device. A hardware key is used to distribute keys among stations so as to enable access to the network for the dedicated network device. Each hardware key comprises a solid state memory. A key is stored in the solid state memory. The solid state memory is configured such that the key is not user modifiable. Thus, users cannot inadvertently delete or change the key.

### PRIORITY CLAIM

This patent application claims the benefit of the priority date of U.S. provisional patent application Ser. No. 60/836,590, filed on Aug. 8, 2006 and entitled KEY MANAGEMENT AND DISTRIBUTION SYSTEMS (docket no. M-16556-V1 US) pursuant to 35 USC 119. The entire contents of this provisional patent application are hereby expressly incorporated by reference.

### TECHNICAL FIELD

The present invention relates generally to networks. The present invention relates more particularly to improvements to network and includes a system and method for key management and distribution in a network, such as a home computer or audio/video network.

### BACKGROUND

Home computer networks are well known. Home computer networks can be used to facilitate communications between computers and other devices. For example, a home computer network can facilitate communications between a plurality of personal computers, a printer, and a cable or DSL modem.

Many home networks use Ethernet. Ethernet is computer networking technology that is well suited for local area networks (LANs). Ethernet defines the wiring and data transmission standards used in the physical layer (the transmission medium) of the network. Means for accessing the data link layer and a common addressing format are also provided.

Ethernet commonly uses a wire medium, such as coaxial cable or Category 5 twisted pair cable. Ethernet can also be wireless, such as according to 802.11x family of technologies. Wireless technologies are gaining popularity because they do not require that wires be installed for the transmission of network information. Installing wires can be expensive and inconvenient. In some instances, installing wires is simply not practical. However, wireless technologies tend to suffer from limited range, radio frequency interference, and potential unauthorized interception.

Home audio/video networks are also well known. Home audio/video networks can be used to facilitate communications between audio/video storage and playback devices and speakers and/or monitors. For example, an audio/video network can facilitate communications between an MP3 player or a stereo and plurality speakers distributed throughout a home. As a further example, an audio/video network can facilitate communication between a DVD player in one room and a television in another room of the home.

Like computer networks, audio/video networks can be either wired or wireless. Also like computer networks, audio/video networks suffer from the problems associated with the use of wired and wireless media as discussed above.

One solution that provides some of the advantages of both wired and wireless media, while lacking some of the disadvantages, is the use of existing home electrical wiring for the transmission of network information. The range is only limited to the extent of the wiring circuit. The system is not particularly susceptible to radio frequency interference, and unauthorized interception is less likely (since nothing is broadcast into the air).

One example of the use of home electrical wiring for the transmission of network traffic is HomePlug®. HomePlug® is an emerging local area network technology that is promoted by the HomePlug® Power Alliance of San Ramon, Calif. A HomePlug® Station is plugged into an electrical receptacle for each network device. An Ethernet connection is made between each network device and its corresponding HomePlug® Station. The HomePlug® Stations then facilitate network communication between devices by transmitting signals over the home's electrical wiring. Circuitry within the HomePlug® Stations prevent the electrical power that is present in the home's electrical wiring from undesirably entering the computer devices (where it would likely cause damage thereto).

In order to define which computer devices can communicate with one another, a key is used. Those devices having the same key can communicate with one another and are thus considered to be on the same network.

However, a common problem associated with the use of such keys is how they are to be distributed. It is often not desirable to distribute the keys via the network, e.g., the home electrical wiring, because keys distributed in this manner are subject to being intercepted. Keys that are intercepted can be used to gain unauthorized access to the network.

The use of solid state memories to distribute keys to network devices is known. For example, USB drives can be used to distribute 802.11x keys to laptop computers in a wireless network. However, the use of USB drives to distribute keys requires that a user define a key (such as by using one of the network's computers), transfer the key to the USB drive, and then distribute the key to each network device. Furthermore, the user must take care to define a key that is compatible the network (that has the correct number of characters, any required characters, and no prohibited characters). More than one key (as well as other information) can be stored on a USB drive.

This contemporary method for key distribution is inconvenient. A personal computer is required for the generation of the key. Not all networks have a personal computer. Even when one is available, using it to generate the key is an inconvenience.

Further, there is the possibility of confusion and error when using such a key distribution procedure. The wrong key or an incompatible key can be defined, this wrong or incompatible key can be transferred to the USB drive, and/or the wrong or incompatible key can be transferred from the USB drive to the network device. In each of these instances, the procedure must, at least in part, be repeated in order for all of the network devices to function properly. Repeating the process adds to the inconvenience.

As such, although the prior art has recognized, to a limited extent, the problems associated with key distribution, the proposed solutions have, to date, been ineffective in providing a satisfactory remedy. Therefore, it is desirable to provide a way to conveniently distribute keys to network devices wherein the potential for errors is substantially mitigated and convenience is substantially enhanced.

### BRIEF SUMMARY

Systems and methods are disclosed herein to provide key management and distribution for local area networks. The local area networks can be computer networks, audio/video networks, or any other desired type of networks. For example, in accordance with an embodiment of the present invention, a hardware key is used for distributing software keys (keys that can be comprised of a string of characters or hexadecimal numbers) among network devices. The hardware key can comprise a solid state memory. A software key can be stored in the solid state memory of the hardware key.

The key can be used to enable a network device to communicate via the network. Those network devices that are enabled with the same software key (such as by using the same hardware key) define a network. Those network devices that are enabled with a different software key (such as by using a different hardware key) define a different network. According to one embodiment of the present invention, different networks do not communicate with one another. Thus, the use of different hardware keys facilitates the determination of which network device communicate with each other and which network devices do not communicate with each other.

The solid state memory can be configured such that the software key is not user modifiable. That is, the user cannot easily delete or change the software key. Thus, the user is less likely to attempt to use a wrong or incompatible software key.

More specifically, in accordance with one embodiment of the present invention the software key is stored in the solid state memory of the hardware key prior to the hardware being provided to the user. For example, the software key can be stored in the solid state memory by a manufacturer or reseller. Thus, the user need only select the correct hardware key to be certain that the correct software key has been selected. Selection of the correct hardware key can be facilitated by labeling, color coding, or the like. Since the correct hardware key can easily be visually identified, the likelihood of error is substantially mitigated.

The solid state memory can comprise a read only memory. Alternatively, the solid state memory can comprise a re-writable memory that is configured such that the ability to re-write to the solid state memory after the software key has been stored is not enabled. For example, the solid state memory can comprise an electrically erasable programmable read only memory (EEPROM) wherein the ability to re-write to the solid state memory is not enabled.

The ability to write to the solid state memory after the software key has been stored can be disabled by modifying the memory chip itself. For example, a wire bond of the memory chip can be omitted or severed so as to inhibit writing to the memory chip. Similarly, circuitry of the chip necessary for writing thereto can be omitted or modified to prevent further writing thereto after the key has been stored on the memory chip. If circuitry of the chip is omitted from the chip, then other circuitry, not part of the chip, can be used to effect writing of the key thereto, such as by the manufacturer.

Alternatively, the ability to write to the solid state memory can be disabled by not providing electrical connection to a pin of the chip or by not providing or by modifying circuitry associated with the solid state memory. For example, circuitry required to effect writing to the solid state memory can be omitted or modified to inhibit writing to the solid state memory. In this manner, the user does not have the required mechanism for changing the contents of the solid state memory.

The hardware key can comprise a housing for the solid state memory. The housing can be configured for use with a home electrical wiring adapter or station. Thus, the housing can be configured to mate with, e.g., be at least partially received within, a station. The housing can be generally configured in the shape of a key. A complimentary opening can be provided in the station for the hardware key. The opening can be configured generally in the shape of a keyhole. Thus, the hardware key can be used in a manner that is somewhat similar to the use of a house key in a door lock. That is, the key-like hardware key can be inserted into the keyhole of a station so as to effect unlocking (providing the key).

A light, such as a light emitting diode (LED) can be provided on the hardware key. The light can be configured so as to indicate when a key has been copied from the apparatus to a network device. In this manner, a user is notified that the network device is authorized to communicate on the local area network. The light can illluminate immediately upon inserting a key into a station that already has the key of that particular hardware key, so as to indicate to the user that the network device is already part of the desired network. Such a light can either alternatively or additionally be provided on the station.

According to one embodiment, the present invention comprises a system for facilitating communication of network information via home electrical wiring. The system comprises a station comprising a key interface for receiving a key from a solid state memory. The key enables a network communication when it matches a key of the communication. A hardware key facilitates the distribution of keys among stations. The hardware key comprises a solid state memory having a key stored therein. The solid state memory is configured such that the key is not user modifiable.

The system can comprise a network circuit configured to communicate with a network device via Ethernet. Further, the station can comprise a power coupler configured to modulate and demodulate home electrical power with network communications.

According to an embodiment, the present invention comprises a network comprising a plurality of stations. Each station can be configured to plug into an electrical receptacle and to facilitate network communications via home electrical wiring. A hardware key can facilitate distribution of keys among stations. The hardware key can comprise a solid state memory having a key stored therein. The solid state memory is configured such that the key is not user modifiable.

According to an embodiment, the present invention comprises a system of networks. Each network can comprise a plurality of network devices. Each network device can use a key to define membership to a particular one of the networks.

According to an embodiment, the present invention comprises a station for facilitating communication of network information via home electrical wiring and the station comprises three prongs configured to be received by an electrical receptacle. The ground prong can be used to enhance a stability of a mechanical attachment of the station to the electrical receptacle. The ground prong does not necessarily provide an electrical connection to circuitry within the station. Indeed, ground prong can be formed of a non-conductor. For example, the ground prong can be formed of plastic.

Since the solid state memory is configured such that the key is not user modifiable, users cannot inadvertently delete or change the key. Thus, each hardware key is always ready for use with it corresponding network.

According to an embodiment, the present invention comprises a speaker/station. The speaker/station can comprise a housing, at least one speaker disposed at least partially within the housing, and prongs attached to the housing. The prongs can be configured to be received within an electrical receptacle. A powerline interface can be disposed within the housing such that the powerline interface is in electrical communication with the speaker and the prongs.

A key interface circuit can be disposed within the housing and can be configured so as to facilitate use of the power powerline interface only after a software key has been communicated to the key interface circuit. A keyhole can be formed in the housing so as to accept a hardware key. The hardware key can have the software key stored therein.

The prongs can be configured so as to rotate in a manner that facilitates mounting of the speaker/station either horizontally or vertically. The speakers can comprise a plurality of speakers having different sizes.

According to an embodiment, the present invention comprises a network adapter. The network adapter can comprise at least one receptacle configured to communicate electrical power from home wiring and at least one network connector configured to communicate network information via home wiring.

The network adapter can be configured to replace a standard receptacle box. The receptacles and the network connectors can be at least partially contained within a common housing. The housing can be configured in the manner of a housing of a standard receptacle box, so as to facilitate interchangeability.

A powerline interface circuit can be disposed within the housing and can be configured to facilitate network communication between a network device connected to one of the network connectors and home wiring. A key interface circuit can be disposed within the housing and can be configured so as to facilitate use of the powerline interface only after a software key has been communicated to the powerline interface. The key interface circuit can be configured so as to facilitate use of the powerline interface only after the software key has been communicated to the powerline interface via insertion of a hardware key into the keyhole.

This invention will be more fully understood in conjunction with the following detailed description taken together with the following drawings.

### BRIEF DESCRIPTION OF THE DRAWINGS

FIG. 1 is a block diagram showing a plurality of networks according to an exemplary embodiment of the present invention;

FIG. 2 is a diagram showing the use of a plurality of stations that facilitate the distribution of audio throughout a home according to an exemplary embodiment of the present invention;

FIG. 3 is a diagram showing a station that facilitates the use of an MP3 player or a stereo so as to define a source of audio, such as for broadcast to the plurality of stations shown in FIG. 2, according to an exemplary embodiment of the present invention;

FIG. 4 is a diagram showing the use of a station for providing Internet access, such as to one or more personnel computers that can be distributed throughout a home in a manner analogous to that shown in FIG. 2, according to an exemplary embodiment of the present invention;

FIG. 5 is a diagram showing a television attached to a station according to an exemplary embodiment of the present invention;

FIG. 6 is a diagram showing a video source, e.g., a DVD player or a set top box, connected to a station so as to provide a source of video according to an exemplary embodiment of the present invention;

FIG. 7 is a front view showing station that is configured for use in audio/video networking applications, according to an exemplary embodiment of the present invention;

FIG. 8 is a side view of the station of FIG. 7;

FIG. 9 is a bottom view of the station of FIG. 7, showing audio and video jacks thereof;

FIG. 10 is a front view showing a station that is configured for use in computer networking applications, according to an exemplary embodiment of the present invention;

FIG. 11 is a side view of the station of FIG. 10;

FIG. 12 is a bottom view of the station of FIG. 10, showing the Ethernet port thereof;

FIG. 13 is a block diagram showing components of a station, according to an exemplary embodiment of the present invention;

FIG. 14 is a diagram schematically showing a hardware key and a station, according to an exemplary embodiment of the present invention;

FIG. 15 is an enlarged front view showing the hardware key of FIG. 14;

FIG. 16 is an end view showing the hardware key of FIG. 14;

FIG. 17 is a side view showing the hardware key of FIG. 14;

FIG. 18 is a top view showing the solid state memory of FIG. 14;

FIG. 19 is a block diagram showing signal lines of the solid state memory of FIG. 14;

FIG. 20 is a diagram showing the use of a plurality of speakers having built-in stations, i.e., speaker/stations that facilitate the distribution of audio throughout a home, according to an exemplary embodiment of the present invention;

FIG. 21 is a front view showing a speaker/station of FIG. 20;

FIG. 22A is a is back view of the speaker/station of FIG. 21, showing the prong assembly of the speaker/station rotated so as to facilitate vertical mounting of the speaker/station;

FIG. 22B is a is back view of the speaker/station of FIG. 21, showing the prong assembly of the speaker/station rotated so as to facilitate horizontal mounting of the speaker/station;

FIG. 23 is a side view of the speaker/station of FIG. 21;

FIG. 24 is a front view of an electrical receptacle box having a built-in network adapter, such as for Internet connectivity, according to an exemplary embodiment of the present invention;

FIG. 25 is a side view of the electrical receptacle box of FIG. 24;

FIG. 26 is an electrical schematic showing the use of a powerline transceiver chip to facilitate communication via home wiring according to an exemplary embodiment of the present invention;

FIG. 27 is an electrical schematic showing circuitry associated with the use of the powerline transceiver chip of FIG. 26;

FIG. 28 is an electrical schematic showing circuitry associated with the use of the powerline transceiver chip of FIG. 26;

FIG. 29 is an electrical schematic showing circuitry associated with the use of the powerline transceiver chip of FIG. 26;

FIG. 30 is an electrical schematic showing circuitry associated with the use of the powerline transceiver chip of FIG. 26;

FIG. 31 is an electrical schematic showing circuitry associated with the use of the powerline transceiver chip of FIG. 26;

FIG. 32 is an electrical a schematic showing circuitry associated with the use of the powerline transceiver chip of FIG. 26;

FIG. 33 is an electrical schematic showing the use of an electronically erasable programmable read only memory (EEPROM) to facilitate key distribution according to an exemplary embodiment of the present invention;

FIG. 34 is an electrical a schematic showing circuitry associated with the use of the EEPROM of FIG. 33;

FIG. 35 is an electrical a schematic showing circuitry associated with the use of the EEPROM of FIG. 33;

FIG. 36 is an electrical a schematic showing circuitry associated with the use of the EEPROM of FIG. 33;

FIG. 37 is an electrical a schematic showing circuitry associated with the use of the EEPROM of FIG. 33;

FIG. 38 is an electrical a schematic showing circuitry associated with the use of the EEPROM of FIG. 33;

FIG. 39 is an electrical a schematic showing circuitry associated with the use of the EEPROM of FIG. 33; and

FIG. 40 is an electrical a schematic showing circuitry associated with the use of the EEPROM of FIG. 33.

Embodiments of the present invention and their advantages are best understood by referring to the detailed description that follows. It should be appreciated that like reference numerals are used to identify like elements illustrated in one or more of the figures.

### DETAILED DESCRIPTION

Contemporary home electrical wiring based networking products require the use of a personal computer to configure the encryption that is utilized for networking security. According to an exemplary embodiment, the present invention uses a hardware key (a physical key) so as to eliminate the need for a personal computer and thereby provide a system that has enhanced plug and play capabilities. This system allows not only for secure encryption, but also allows multiple home electrical wiring adapters or stations to recognize each other and form multiple sub-networks within a home electrical wiring network environment. The home electrical wiring network environment can be a single home or a group of homes.

According to an exemplary embodiment of the present invention, a hardware key has an encryption code or software key embedded therein. For example, the software key can be stored in a solid state memory. The solid state memory can be a chip, such as a chip that is mounted upon a printed circuit board (PCB). The key can be accessed via a connector, such as a mini USB or I2C connector.

An exemplary embodiment of the present invention can utilize an interface circuit that implements the HomePlug® 1.0 MAC while providing enhanced performance. The HomePlug® 1.0 MAC uses different encrypted key to separate different logical networks on the same home electrical wiring. Because home electrical wiring is a shared media, unique encrypted keys are necessary to prevent intended or unintended eavesdropping from neighborhood devices. In addition, the MAC implements a carrier sense multiple access/collision avoidance (CSMA/CA) algorithm to reduce the collision caused by simultaneous transmission from different stations.

An exemplary embodiment of the present invention, like HomePlug® 1.0, can use standard DES encryption to define networks. Each station can have two keys. One can be the default key and the other can be the network key. Devices with the same default key can communicate with each other. If a new device with a different default key is plugged into the home electrical wiring network, then the original devices are initially not able to identify or communicate with the new device. According to contemporary practice, the default key is set to be “HomePlug ®” by the manufacture. The network key is generated by a random number generating algorithm.

According to contemporary practice, the new device is connected to a personal computer and the personal computer is used to provide the appropriate key for the network. For example, a user can use a vendor's graphical user interface (GUI) to change the default key of the local device to the same default key of the original device. After the default key is changed, the network devices can communicate with each other.

Even though this is a straightforward approach, it is an inconvenience to use a personal computer to distribute the software key. It is particularly inconvenient when a personal computer is not connected to the new device. For example, there may not be Ethernet port available in some embedded audio or video applications. Therefore, HomePlug® 1.0 provides the second method for distributing the software key. By knowing the remote key of the device (usually it is printed at the bottom of the HomePlug® device), a remote HomePlug® device can set the appropriate software key via the home electrical wiring.

According to an exemplary embodiment of the present invention, key distribution can be facilitated without using a personal computer. Such key distribution can be accomplished via the use of a hardware key or via time based methodology, as discussed in detail below.

According to an exemplary embodiment of the present invention, each station has an associated hardware key that is provided by the manufacturer so as to determine which network the station is associated with. The hardware key is the same (contains the same software key) for each device on a particular network. The hardware keys can be provided with the stations, or separately therefrom.

More than one hardware key (and thus more than one software key) can be associated with a particular station. Thus, a particular network device can belong to more than one network. A network device will communicate with all of the networks for which a software key has been provided to the station of the network device.

The hardware key can comprise a EEPROM, ROM, or the like that is used to store a unique default key and/or remote key. When the physical key is plugged into the station, the default key and/or remote key stored in the EEPROM either replace or add to any default keys and/or remote keys stored therein. A button on either the hardware key of the station can be used to determine whether the new key(s) replace or add to existing key(s). Therefore, if there are multiple stations on the network, each with different default keys, the user can use a single hardware key to provide all devices with the same default key and/or network key and thereby assure that all of the network devices can communicate with each other.

Because an interface circuit of the present invention can support the I2C interface, an I2C EEPROM can be used as the solid state storage device. This approach is independent of home electrical wiring quality. Therefore, it is robust with respect to home electrical wiring imperfections such as noise, attenuation, etc. Moreover, this approach prevents eavesdropping from the home electrical wiring.

Alternatively, the present invention can use a time based key method wherein each station is provided with a memory device from manufacturer. When the memory device is plugged into the station, the local key is broadcast on the network, e.g., the home electrical wiring, periodically (for example, once every second) for some period of time (for example, five minutes). Meanwhile, the user goes to all of the other stations on the network and locks the key within the five minute time window. The locking process causes the station to accept the key being broadcast. Thus, each of the stations on the network accepts and uses the key that is broadcast from first station.

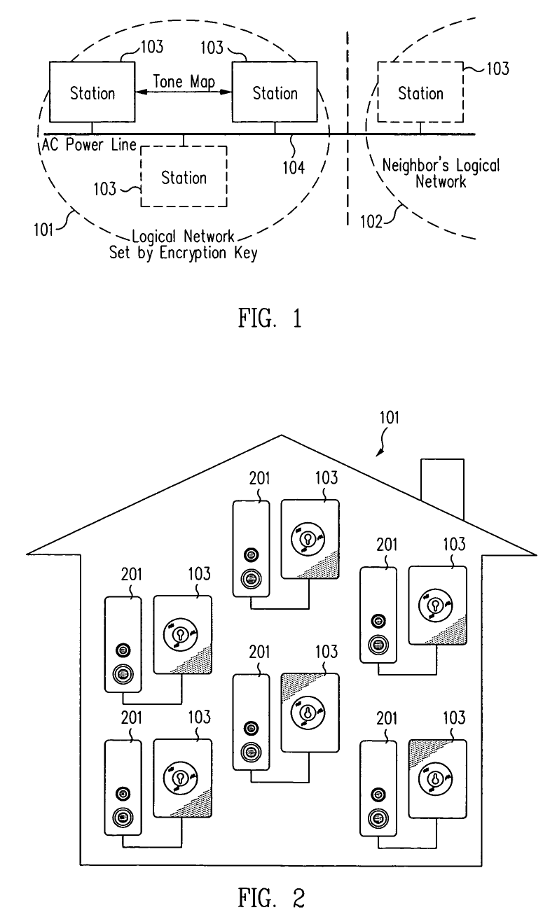

Referring now to FIG. 1, a local area network 101 for one home facilitates communication between network devices within that home. Similarly, a local area network 102 for a neighbor's home facilitates communication between network devices within the neighbor's home. Communication between network devices is facilitated by a plurality of stations 103. Each station 103 is a hardware device that provides an interface between a network device and the home's electrical wiring 104, according to well know principles. Thus, the home's electrical wiring 104 is the medium used to communicate information between network devices.

It is worthwhile to appreciate that the dashed vertical line that separates one home from another in FIG. 1 can be arbitrarily repositioned so as to define a new network configuration. For example, the dashed line can be moved to the left such that part of the network 101 of the first home extends into the second home (thus dividing network 101 among the first and second homes). The dashed line can be moved far enough to the left such that all of the network 101 is in the second home (thus providing the second home with two complete and separate networks).

Network devices can include computer devices such as personal computers, printers, routers, switches, modems, and storage (such as network attached storage or NAS). Network devices can also include audio/video devices such as stereos, MP3 players, DVD players, set top boxes, speakers, and monitors.

Referring now to FIG. 2, a home having at least one local area network 101 is shown. The local area network(s) are defined by a plurality of stations 103 that are plugged into electrical outlets of the home so as to facilitate the communication of network information via the home's electrical wiring (104 of FIG. 1). A network device 201 is in electrical communication with each station 103.

The network devices are depicted as speakers in FIG. 2. However, as discussed above, a variety of different types of network devices can communicate via the local area network. Thus, the network device can be audio/video devices, computer devices, or any other desired type of devices.

A plurality of networks can be defined within a home. Thus, not all of the stations (and consequently the network devices) necessarily belong to the same network. Some of the stations can belong to one network, others to another network, and others to yet another network. Any desired number of local area networks can be so defined. For example, the upstairs of FIG. 2 can have one audio/video network and the downstairs of FIG. 2 can have another audio/video network. The manner in which the keys are distributed can result in the definition of sub-networks (networks within networks) and/or overlapping networks (wherein some, but not all, network devices belong to more than one network).

The different networks can be of different, i.e., mixed, types. Thus, some of the upstairs stations 103 can define a first computer network and some can define a first audio/video network. Similarly, some of the downstairs stations 103 can define a second computer network and some can define a second audio/video network. In this manner, four separate networks are defined.

A network device can belong to more than one type of network. For example, a personal computer can belong to both a computer network and an audio/video network. This can be done by providing the personal computer with two software keys, i.e., one software key of the computer network and one software key for the audio/video network. The personal computer can be used for routine computer applications on the computer network and can be use as a source of audio and/or video on the audio/video network.

The networks can be configured such that network information is only communicated to network devices within a network. Thus, the downstairs network will not communicate with the upstairs network if the two networks are set up as separate networks, i.e., do not have any common software keys. Thus, the networks can be set up as separate networks by providing separate keys for each and by not providing a common key to both.

Alternatively, different networks can be set up to have different keys and also to have a common (the same) key, as well. Thus, two different networks can use their common key to communication network information therebetween.

In some instances local area networks can extend between homes (such as from one home to another). Thus, two or more homes can be on the same network.

Multiply networks, overlapping networks, and/or mixed networks can be defined logically. The use of such logical networks provides flexibility in determining how many and what type devices can be on a network and the physical layout of the network.

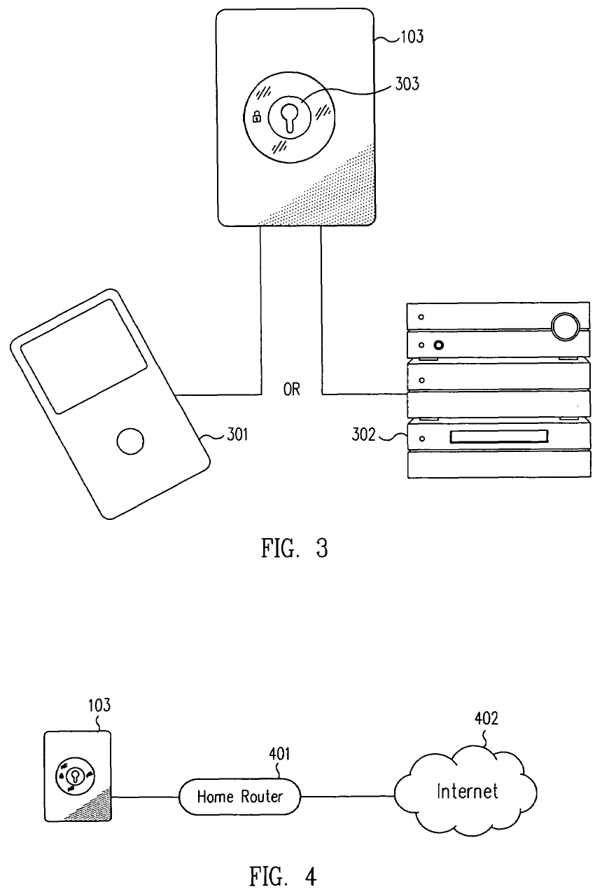

Referring now to FIG. 3, according to an exemplary embodiment of the present invention a station 103 can be configured to communicate audio and/or video information via home electrical wiring. For example, a station 103 can be configured to receive an audio input from an MP3 player 301 or from a stereo 302. This audio information can then the broadcast via the home's electrical wiring system 104 (FIG. 1) to a plurality of stations 103 that are connected to speakers 201 as shown in FIG. 2. A station 103 that functions as a source of audio/video for other stations or devices can thus be a hub of an audio/video network.

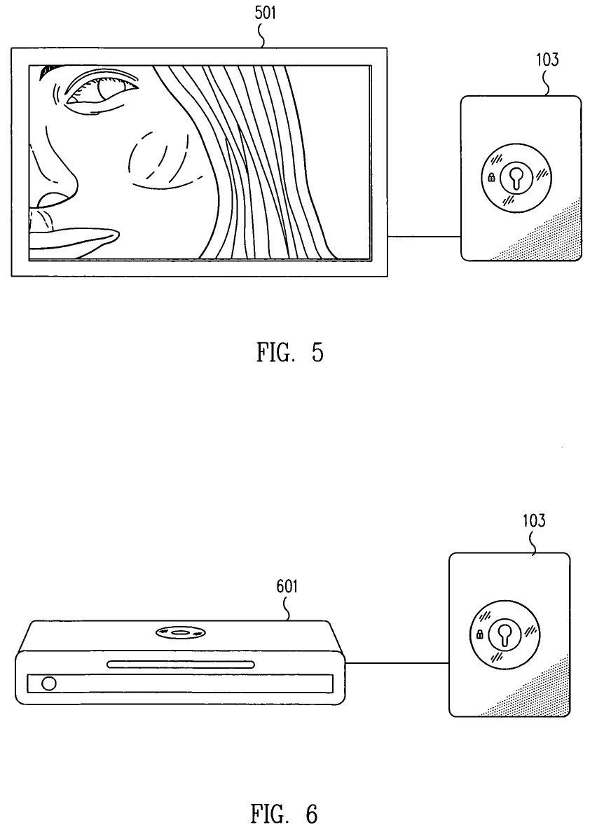

Referring now to FIG. 4, according to an exemplary embodiment of the present invention a station 103 can be configured to communicate computer information via home electrical wiring. For example, a station 103 can be configured to communicate data via a router 401 that is connected to the Internet 402. This information can be communicated to other computer network devices, such as personal computers. This information can also be communicated to audio/video devices. For example, movies can be communicated via the Internet 402 to a television 501 (FIG. 5).

A station 103 can be configured to communicate multiple types of information via home electrical wiring. Thus, one station 103 can be configured to communicate both computer information, e.g., digital information, and audio/video information, e.g., analog information, via home electrical wiring. Indeed, a station 103 can be configured to communicate any desired type of information or combination of types of information via home electrical wiring.

Referring now to FIG. 5, a station 103 that is configured to communicate audio/video information can be connected to a television 501. Thus, television 501 does not have to be in the same room as the source of the audio video information, e.g., a DVD player or a set top box.

Referring now to FIG. 6, a station 103 that is configured to communicate audio/video information can be connected to a DVD player 601. As mentioned above, DVD player 601 can be in a different room with respect to the television used to watch a DVD. Further, a plurality of televisions or other audio/video network devices can be connected as shown in FIG. 5 so as to receive a signal from a single audio/video source and/or a plurality of such audio/video sources can provide signals to one or more televisions or other audio/video devices. Thus, the output of DVD player 501 can be broadcast to a plurality of televisions 501 (such as via a corresponding number of stations 103).

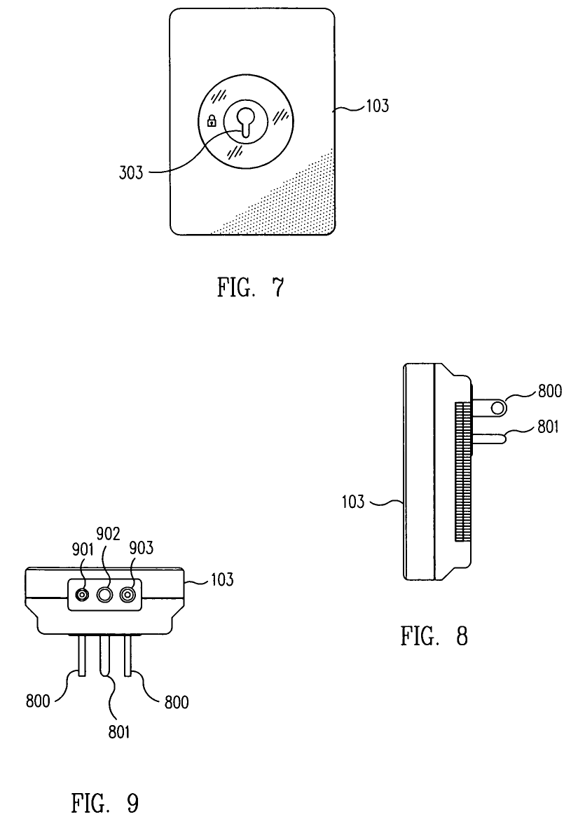

Referring now to FIG. 7-9, a station 103 that is configured for the communication of audio/video, e.g., analog, information is shown. Although station 103 is depicted as a generally rectangular box, those skilled in the art will appreciate that various other configurations are likewise suitable.

With particular reference to FIG. 7, the station 103 can comprise a keyhole 303 that is configured to receive a hardware key (such as hardware key 1401 of FIG. 14). The hardware key can have a software key stored therein. The software key can be the default key, the network (remote) key, or both. The software key can be the key that is used to define logical networks.

With particular reference to FIG. 8, a three-prong plug can be used to attach station 103 to a home electrical wiring receptacle. Although only two plugs 800 are required for electrical communication, the third or ground plug 801 can be provided to enhance the mechanical attachment of station 103 to the receptacle. Ground plug 801 does not need to be electrically connected within station 103. Indeed, ground plug 801 can be formed of a non-conductor such as plastic.

With particular reference to FIG. 9, station 103 can have one or more audio/video connectors to facilitate communication with audio/video devices. For example, station 103 can have a single audio connector (which can be either monaural or stereo), a pair of audio connectors 902 and 903 (which can be stereo), and/or a video connector 901. Indeed, station 103 can have any desired number of such connectors, as well as any desired number of connectors for computer data (such as Ethernet connectors), so as to facilitate the communication of a desire number of signals or channels.

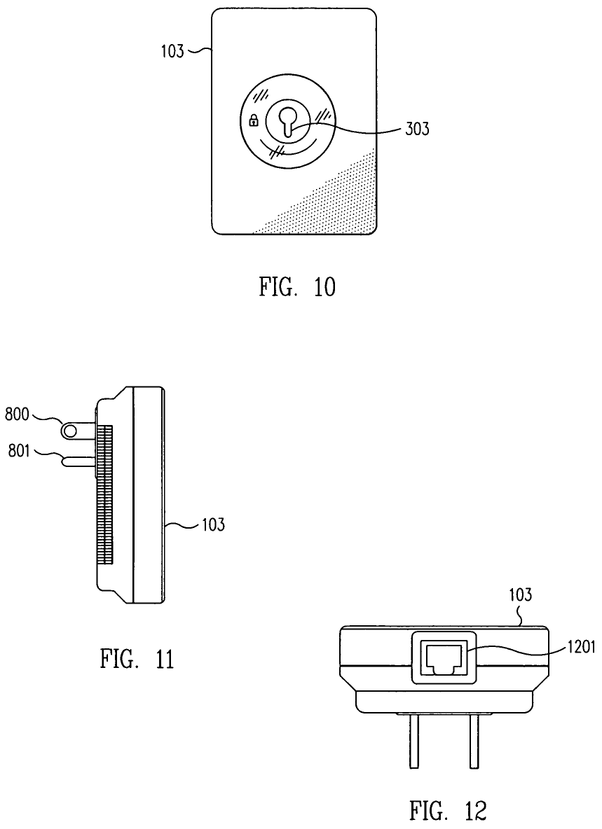

Referring now to FIGS. 10-12, a station 103 that is configured for the communication of computer, e.g., digital, information is shown. Although station 103 is depicted as a generally rectangular box, those skilled in the art will again appreciate that various other configurations are likewise suitable.

With particular reference to FIG. 10, the station 103, like that shown in FIG. 7, can comprise a keyhole 303 that is configured to receive a hardware key.

With particular reference to FIG. 11, a three-prong plug can again be used to attach station 103 to a receptacle. Again, the ground plug need not be electrically connected to circuitry within station 103 and can be used only for mechanical attachment of station 103 to the receptacle.

With particular reference to FIG. 12, station 103 can have one or more computer connectors. For example, station 103 can have an Ethernet port 1201 to facilitate communication with computer network devices.

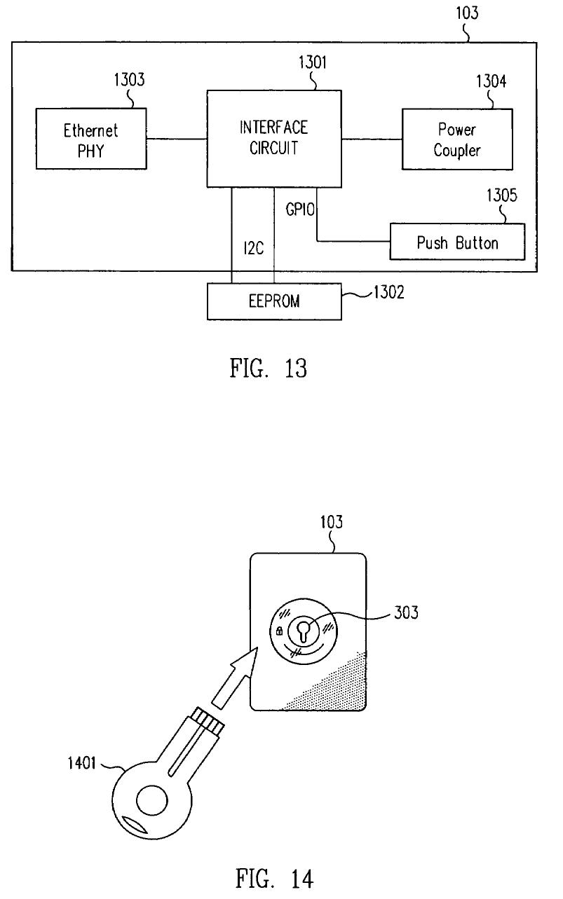

Referring now to FIG. 13, a block diagram shows some components of a station 103. A station 103 can comprise an interface circuit 1301 that facilitates communication with an external memory device, such as EEPROM 1302 of hardware key 1401 (FIG. 14). The software key can be stored upon this external memory device. Communication between interface circuit 1301 and EEPROM 1302 can be via a mini USB interface or an I2C interface, for example.

When the correct key (the key for the local area network that station 103 is part of) has been provided to interface circuit 1301 in a network communication, then interface circuit 1301 enables network communications using an Ethernet physical circuit 1303 with computer devices on the same local area network. Alternatively, communications with audio/video devices can be enabled. Indeed, communications with any desired combination of computer and audio/video devices can be so enabled.

A power coupler 1304 facilitates communication of the network device connected to station 103 with the network via the home's electrical wiring. That is, power coupler 1304 modulates information from a network device attached to station 103 so that the information can be communicated via the home's electrical wiring and coupler 1304 also demodulated information from the home's electrical wiring so that the information can be communicated to the network device.

A push button 1305 can be used to cause interface circuit 1301 to copy a software key from EEPROM 1302. Thus, to load a key into station 103, a physical key 1401 (FIG. 14) can be inserted into keyhole 303 of station 103. With the physical key 1401 inserted (so that EEPROM 1302 thereof is in electrical communication with interface circuit 1301 via I2C interface), push button 1305 is depressed to initiate the copying process.

Referring now to FIG. 14, as discussed above, hardware key 1401 can be inserted into keyhole 303 of station 103 so as to effect copying of the software key stored in a solid state memory of hardware key 1401 to station 103. Hardware key 1401 can be configured so as to physically resemble a key. Alternatively, hardware key 1401 can have any other desired configuration.

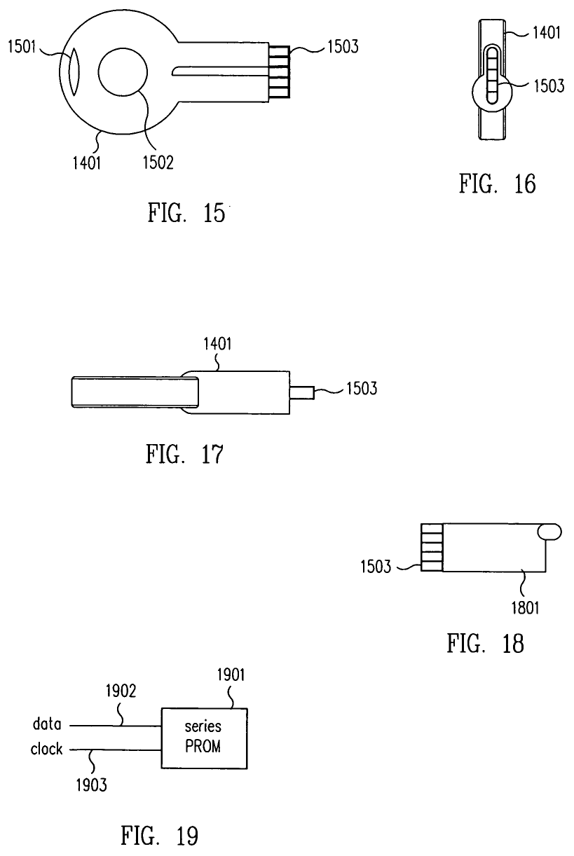

Referring now to FIG. 15-17, hardware key 1401 can have one or more lights 1501 that indicate when hardware key 1501 is properly inserted into station 103 and/or indicate when the key copying process is occurring and/or has been completed. Hardware key 1401 can have a button 1502 that can be depressed to commence the software key copying process.

Referring now to FIG. 18, hardware key 1401 can comprise EEPROM 1801. Connector 1503 can be the connector of EEPROM 1801. Rather than an EEPROM, the solid state memory can comprise a ROM or any other type of solid state memory. Indeed, the memory can alternatively comprise a non-solid state memory, such as a miniature hard drive or an optical memory device.

Referring now to FIG. 19, a block diagram of hardware key 1401 shows that the memory can be a series PROM having a data line 1902 and a clock line 1903. Clock line 1903 can control (clock) the communication of data via data line 1902.

The solid state memory can comprise any type of solid state memory that is inherently configured such that a user cannot modify a key stored therein or that can be configured such that a user cannot modify a key stored therein. Thus, the solid state memory can comprises read only memory (ROM). Alternatively, the solid state memory can comprise re-writable memory such as random access memory (RAM). For example, the solid state memory can comprise programmable read only memory (PROM) electronically erasable programmable read only memory (EEPROM) that has been configured so as to inhibit deleting or changing a key stored therein.

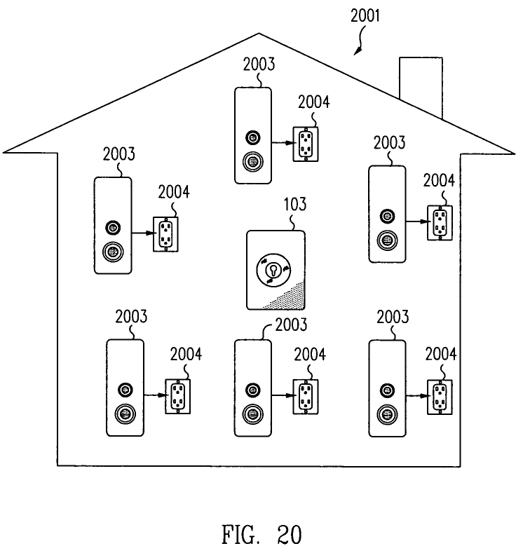

Referring now to FIGS. 20-23, an audio/video local area network 2001 can comprise at lest one station that functions as a hub 103 (see also FIG. 3) and at least one speaker/station 2003. For example, the audio local area network 2001 can comprise one hub 103 and a plurality of speaker/stations 2003, as shown.

Each hub 103 can plug into home wiring, such as via an electrical receptacle 2004, so as to facilitate communication of audio/video via the home electrical wiring. Thus, one or more audio/video devices, such as an MP3 player, a CD player, a DVD player, or the like, can provide audio/video to hub 103. Hub 103 then communicates the audio/video over the home wiring.

Each speaker/station 2003 can comprise a speaker and a station, such as the speakers 201 and the stations 103 of FIG. 2. Thus, speakers and stations can be integrated into a single housing that plugs into a home wiring receptacle 2004. In this manner, speakers may easily and inconspicuously be installed around the home.

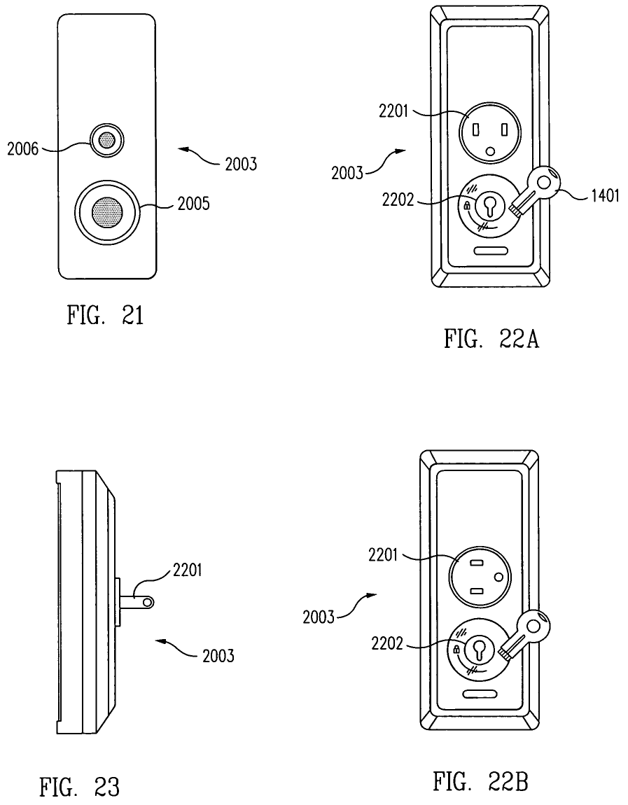

Although the speakers shown in FIGS. 21-23 are approximately the size of the electrical receptacle box, the speaker(s) can be of any desired size. Further, the speakers can attached to the receptacle 2004 via a cord, rather than directly as shown in FIGS. 22-23 wherein the prongs for the receptacle are on the back of the speaker/station 2003. The use of such a cord may be particularly desirable for larger speakers.

With particular reference to FIG. 21, each speaker/station 2003 can comprise one or more larger speakers 2005 and one or more smaller speakers 2006. Any desired combination of any desired size or type of speakers can be used.

With particular reference to FIGS. 22A and 22B, a prong assembly 2201 and a keyhole 2202 can be disposed on the back of speaker/station 2003. Prong assembly 2201 comprises the prongs that are received within the wall outlet or receptacle 2004 (such as in FIG. 20). Optionally, prong assembly 2201 can be configured so as to rotate in a manner that facilitates mounting of speaker/station to the receptacle box (by plugging speaker/station 2003 into receptacle 2004) in a plurality of different orientations.

For example, prong assembly 2201 can be oriented such that speaker/station 2003 can be mounted vertically (with its longitudinal axis vertical), as shown in FIG. 22A. Alternatively, prong assembly 2201 can be oriented such that speaker/station 2003 can be mounted horizontally (with its longitudinal axis horizontal), as shown in FIG. 22B. Thus, a user can mount speaker/station 2003 in the manner that best suits the user.

With particular reference to FIG. 23, the prong assembly can be seen rotated to a position that facilitates vertical mounting of the speaker/station 2003. That is, prong assembly 2201 is oriented in the same position in FIG. 23 as in FIG. 22A.

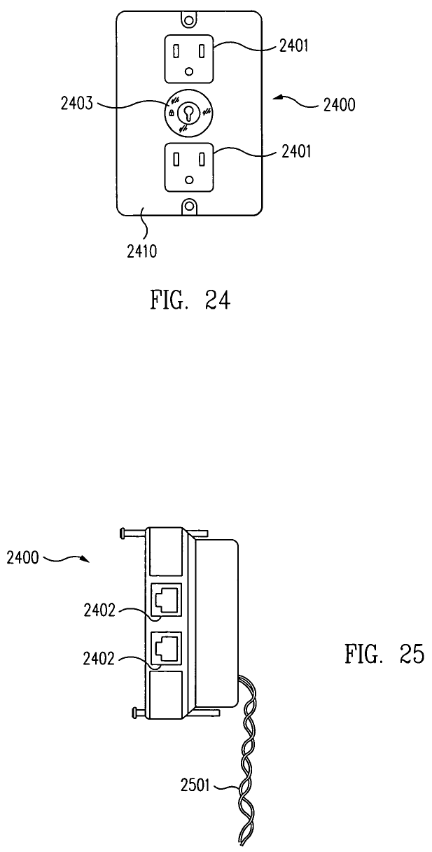

Referring now to FIGS. 24 and 25, a network adapter 2400 for home or business is shown. The network adapter 2400 can replace a standard receptacle box, either as a replacement or in new construction. The network adapter 2400 can provide electricity via two receptacles 2401 in the same manner as a standard home wiring receptacle box. Thus, home appliances, network devices, or any other items intended to plug into a standard receptacle box can plug into network adapter 2300. Additionally, the network adapter 2400 provides Internet or other network access, such as via an Ethernet connection facilitated by network connectors 2502. Network connectors 2402 can be formed on the front, side (as shown in FIG. 25), top, or bottom of the housing 2410 thereof.

A keyhole 2403 facilitates the use of a physical key to distribute software keys, as discussed above. Thus, by inserting a physical key into keyhole 2403, a particular receptacle box 2400 (and consequently the network devices that are attached thereto via network connectors 2402) can be enabled for network access. The network adapter 2400 can be used to facilitate network access for a variety of different network devices, such as computers, printers, scanners, network attached storage (NAS), etc.

Wiring 2501 extends from Internet adapter 2400 to facilitate interconnection home wiring. That is, wiring 2501 can comprise only home electrical wiring. Thus, network information can be communicated over home wiring via the use of an interface circuit as shown in FIG. 13 and as described in further detail below. Alternatively or additionally, wiring 2501 can comprise dedicated network wiring, such as Category 5 or coaxial wiring.

The network adapter 2400 can have any desired number of electrical receptacles 2401 and network connectors 2402. For example, the network adapter 2400 can have one, two, three, four, or more electrical receptacles 2401 and/or network connectors 2402.

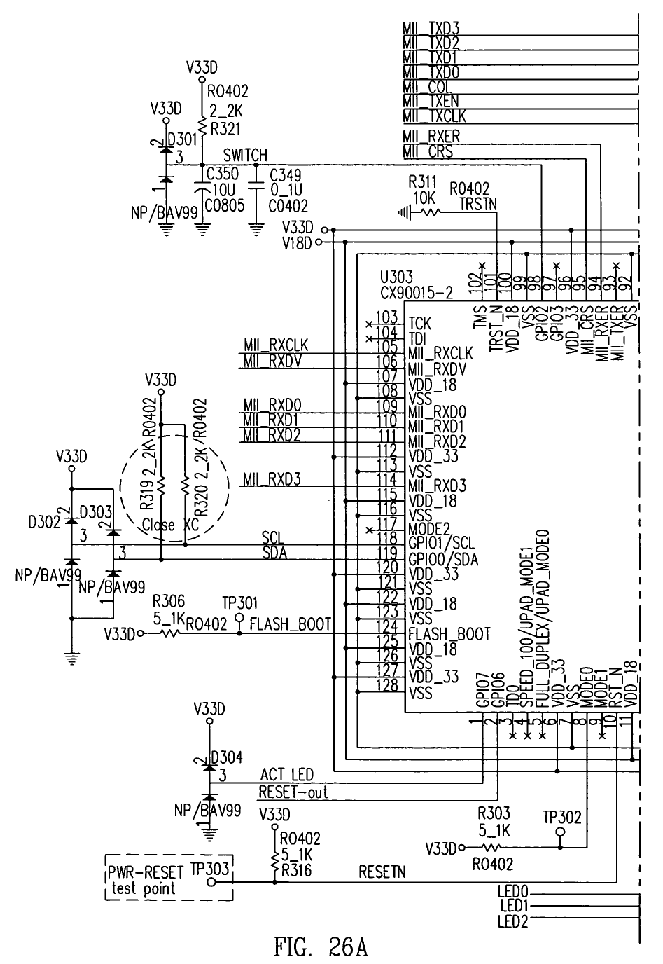

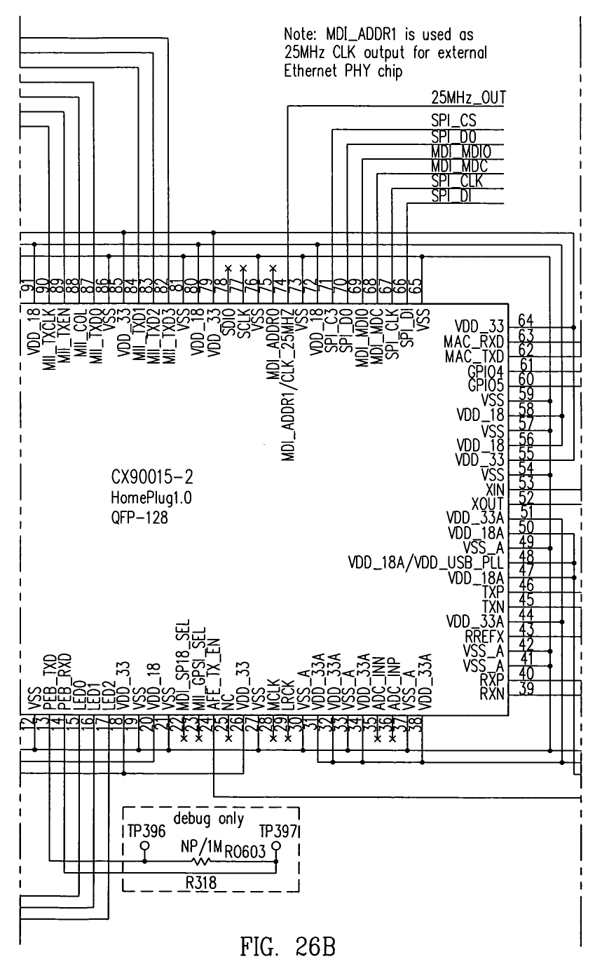

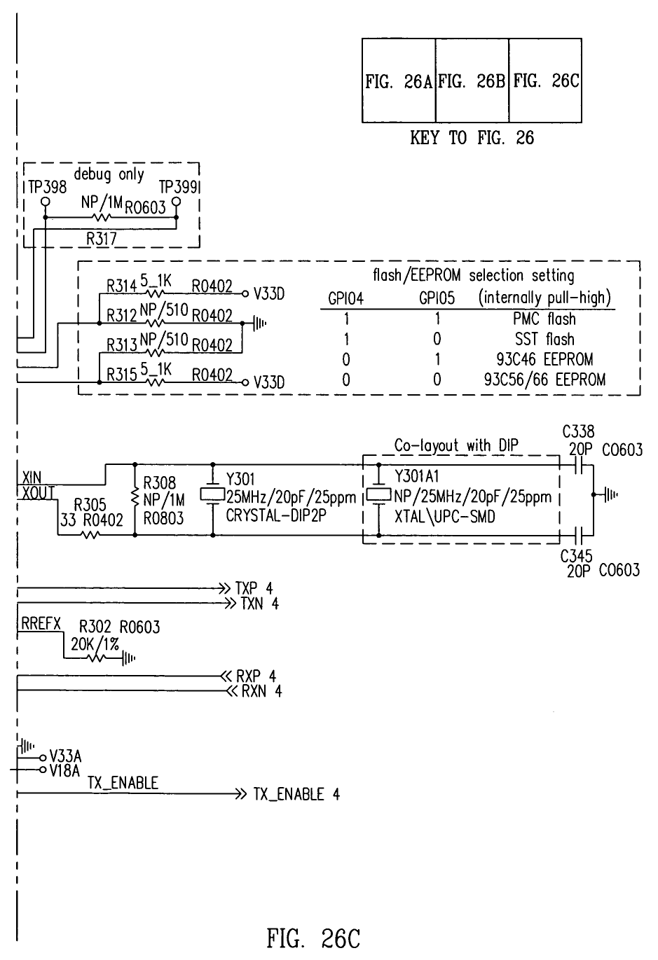

Referring now to FIGS. 26-31, exemplary powerline interface circuitry for facilitating powerline network communications using key distribution according to one or more embodiments of the present invention is shown. Those skilled in the art will appreciate that other circuits may similarly be used to facilitate powerline network communications using key distribution according to one or more embodiments of the present invention.

With particular reference to FIG. 26, a CX90015-2 single chip powerline transceiver facilitates powerline network communications. The CX90015 powerline chip has an integrated OFDM transceiver, MAC, AFE, mCs and USB. The CX90015-2 is a single chip SoC integrated with AFE and is backwardly compatible with 14 Mbps HomePlug1.0 PHY/MAC data rate. It has a data rate of 50/15 Mbps QoS and can use VLAN tagging. It has a COFDM DVB-T demodulator that is compliant with ETS 300 744 and Nordig II.

The CX90015 powerline chip provides significant sensitivity enhancement in a fading environment, superior dynamic multi path performance in a long echo environment, low power consumption, and integrated ADC, PLL, and dual SD AGC. It supports both Ethernet and USB interface to home electrical wiring. It supports MII/GPSI for direct host connection. This chip provides an integrated processor for powerline MAC and Ethernet USB bridge management, an integrated powerline MAC and PHY, and an integrated 10/100 Ethernet MAC. It also provides an integrated powerline analog front end (AFE) including high speed 10-bit ADC/DAC, receiver AGC with 54 dB gain dynamic range with 6 dB per step, a PLL with external low cost 25 MHz crystal, and a low pass filter & bias circuitry. It has orthogonal frequency division multiplexing (OFDM) using signal processing techniques that provide high data reliability in noisy media conditions. It is compliant with IEEE 802.3. It supports Quality of Service (QoS) such as channel access priority, segment-burst and contention-free access. It supports 56-bit DES encryption with key management for secure communication. It supports up to 31 powerline bridges supports up to 256 bridged addresses on powerline network. A MII Host (MAC) (IEEE 802.3u) facilitates direct connection to Ethernet MAC and PHY. It has firmware programming based architecture and firmware can be downloaded and upgraded through MII/USB. This chips high speed turbo mode can provide data rates up to 50 Mbps, and seamless integration with 802.11a/g @ 54 Mbps, backward compatible with HomePlug1.0.

Use of the CX90015-2 powerline interface is by way of example only, and not by way of limitation. Those skilled in the art will appreciate that other chips, as well as discrete and/or hybrid circuits may similarly be used.

Circuitry that facilitates operation of the CX90015-2 powerline interface includes a power voltage distribution circuit, a 64 Kbyte serial flash memory chip, a power voltage transmission line, a data signal path, a connector circuit and testing connection points.

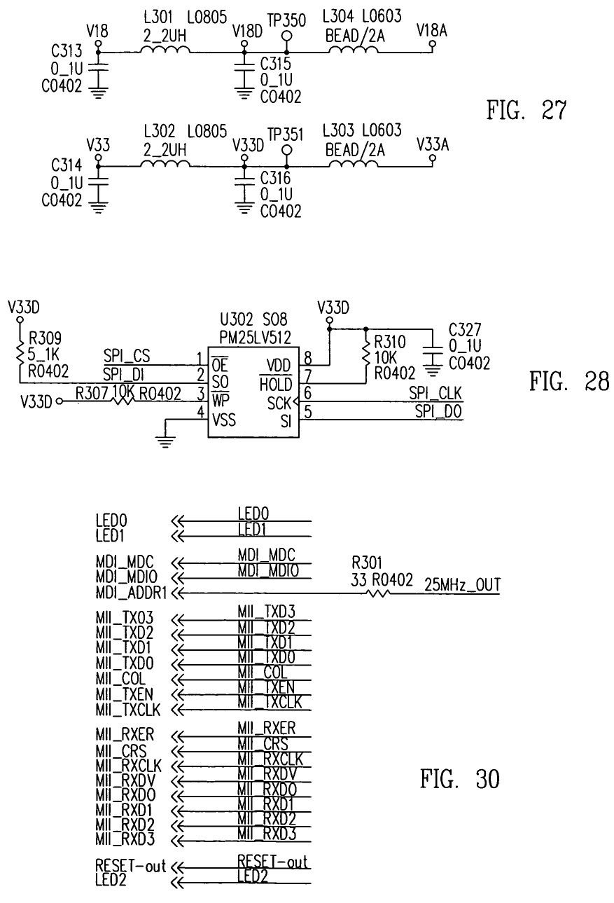

FIG. 27 shows the power voltage distribution circuitry for supplying 3.3 volts and 1.8 volts to the CX90015-2 poweline chip.

FIG. 28 shows the 64 kbyte serial flash memory chip with the associated circuitry for the firmware storage of the powerline network communications.

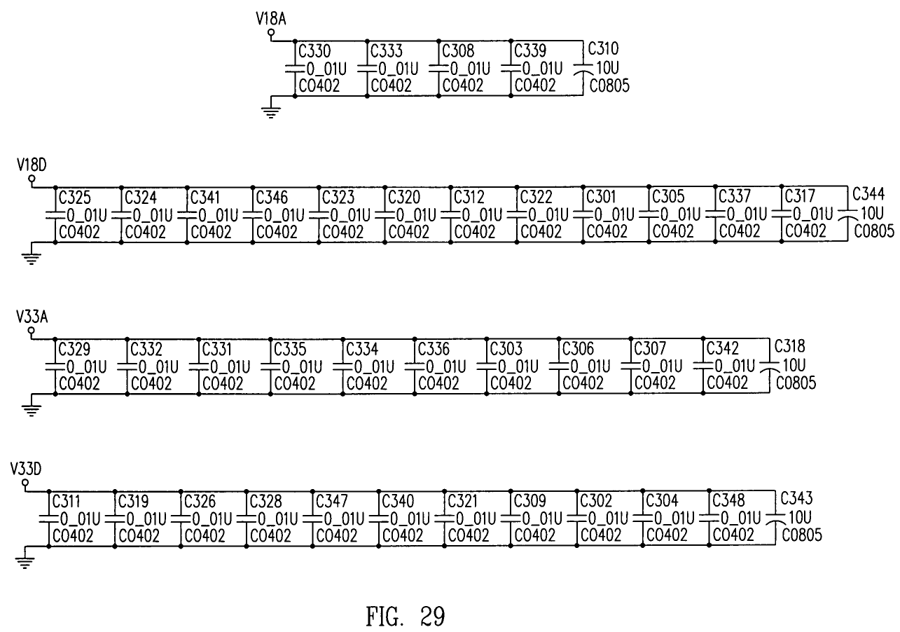

FIG. 29 shows the power voltage transmission line for 3.3 volts and 1.8 volts to the CX90015-2 powerline chip.

FIG. 30 shows the data signal path between the CX90015-2 powerline chip, and an Ethernet Physical chip.

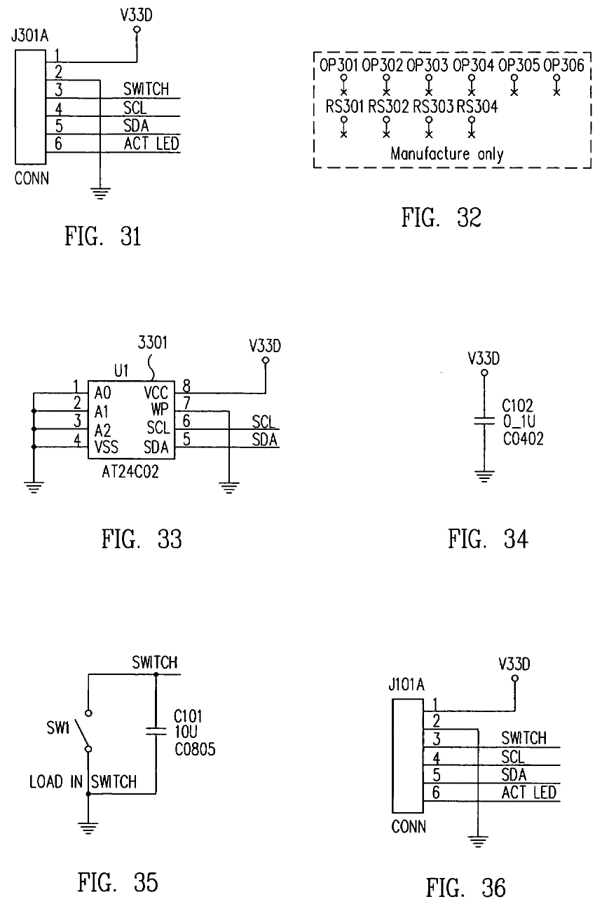

FIG. 31 shows the connector circuitry as the signal bus for power voltage, power ground, switch (SWITCH), serial clock (SCL), serial data (SDA) and activity LED (ACT LED) signals between the 2-wire bus serial EEPROM, AT24C02 and the CX90015-2 power line chip.

FIG. 32 shows the testing connection points for the manufacturing testing.

Referring now to FIGS. 33-40, exemplary physical key circuitry for facilitating powerline network key distribution according to one or more embodiments of the present invention is shown. Such circuitry can, for example, be used in the physical key 1501 of FIG. 14. Those skilled in the art will appreciate that other circuits may similarly be used to facilitate key distribution according to one or more embodiments of the present invention.

With particular reference to FIG. 33, an AT24C02 electronically erasable programmable read only memory (EEPROM) chip 3301 can be used to store the logical or software key. The software key can be burned onto or stored in the EEPROM chip 3301 by the manufacturer, a network administrator, a reseller, or the user. If the software key is stored in the EEPROM chip 3301 by someone other than the user, then ease of use for the user is enhanced and the likelihood of error is mitigated. The hardware key can be configures so that it is not easily erasable by a user.

For example, the software key can be permanently stored on EEPROM chip 3301 by the manufacturer. In this manner, the opportunity for a user to use a wrong software key or to delete the software key is mitigated. Use of the software key is simplified since the user does not have to determine what software key to use (generate a software key), store the software key on a memory device, and be careful to use the memory device with the correct software key, and be careful not to erase the key.

Use of the AT24C02 EEPROM chip is by way of example only, and not by way of limitation. Those skilled in the art will appreciate that other chips, as well as discrete and/or hybrid circuits may similarly be used.

Circuitry that facilitates use of the AT24C02 EEPROM chip 3301 includes a power voltage source circuit, a software-key-read circuit, a signal bus circuit, signal transmission line and LED control signal circuit.

FIG. 34 shows the power voltage source circuitry.

FIG. 35 shows the software-key-read circuitry for providing the input signal (SWITCH) to CX90015-2 chip, a powerline chip, to retrieve the software key in the 2-wire bus serial EEPROM, AT24C02.

FIG. 36 shows the connector circuitry as the signal bus for power voltage, power ground, switch (SWITCH), serial clock (SCL), serial data (SDA) and activity LED (ACT LED) signals between the 2-wire bus serial EEPROM, AT24C02 and the powerline chip, CX90015-2.

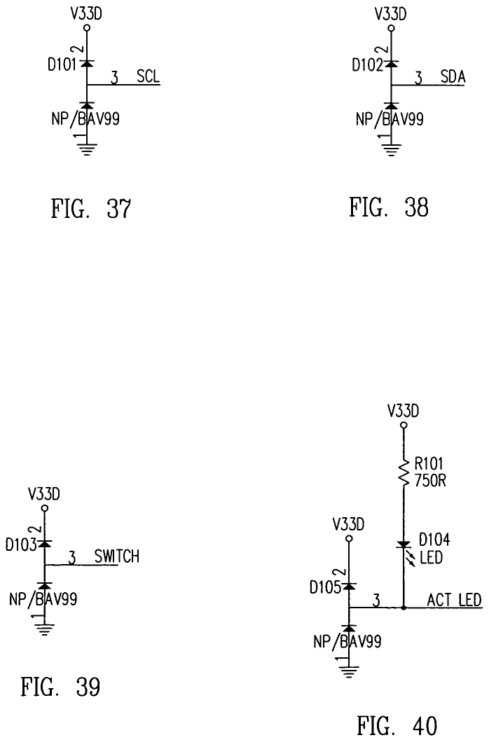

FIG. 37 shows the serial clock (SCL) signal transmission circuitry between the 2-wire bus serial EEPROM, AT24C02 and the connector circuitry of FIG. 36.

FIG. 38 shows the serial data (SDA) signal transmission circuitry between the 2-wire bus serial EEPROM, AT24C02 and the connector circuitry of FIG. 36.

FIG. 39 shows the switch (SWITCH) signal transmission circuitry between the 2-wire bus serial EEPROM, AT24C02 and the connector circuitry of FIG. 36.

FIG. 40 shows the activity LED (ACT LED) signal transmission circuitry between the LED and the connector circuitry of FIG. 36.

As used herein, the term “user modifiable” refers to the ability of a typical user to delete or change information stored on a memory. If the information is user modifiable, then the user can, using only means that are routinely available to users, delete or change the information. For example, the data stored on a contemporary USB drive is user modifiable because a typical user can plug the USB drive into a USB port of a personal computer and can then use the personal computer to delete information on the USB drive and/or can use the personal computer to change information on the USB drive.

Home electrical wiring can be defined to include the wiring used in a home or other building to provide electrical power to the electrical outlets or receptacles thereof. However, it is worthwhile to appreciate that one or more embodiments of the present invention are not limited to use with home wiring systems as the network media.

The description herein discusses the use of an apparatus for storing a key with stations that facilitate network communication via home electrical wiring. However, those skilled in the art will appreciate that such an apparatus can likewise be used with a variety of different network devices. Thus, discussion of use in networks that use home electrical wiring for communication is by way of example only, and not by way of limitation.

The description herein discusses the use of an I2C (I squared C) connection between a station and the apparatus upon which a key is stored. However, those skilled in the art will appreciate that other types of electrical connections are likewise suitable. For example, a standard universal serial bus (USB), a serial port, a parallel port, or a FireWire connection can alternatively be used.

Network devices can include stations, personal computers, network attached storage (NAS), printers, and modems (such as telephone modems, cable modems, DSL models), for example.

A home, as the term is used herein, can mean a house, an office, or any other building or structure. Thus, the term home is not limited to residences.

Since the solid state memory is configured such that the key is not user modifiable, users cannot inadvertently delete or change the key. Thus, each hardware key is always ready for use with it corresponding network. A user is not required to determine if a particular hardware key (one that is designated for use with a particular local area network) has the proper key stored thereon.

The use of home electrical wiring is described herein as the medium via which network communication is facilitated. However, according to an exemplary of the present invention, other media may be used. For example, fiber optics, wireless, and/or infrared may alternatively be used. Indeed, one or more embodiments of the present invention are media independent.

The type of information communicated by the network can be any desired type of information and thus is not limited to computer information and/or audio/video information. For example, control information can be communicated so as to determine when lights are to be on, when blinds are to be closed, etc.

Although discussed herein as a separate device, those skilled in the art will appreciate that a station can be built into a network device. Thus, the speakers of a stereo system, for example, could have the station formed integrally therewith, such that the keyhole is built into each speaker. The user would them simply insert the hardware key into the network device itself, e.g., the speaker, to effect key distribution.

According to one or more embodiments of the present invention, the need to use a computer for the key distribution process is eliminated. Instead, a hardware key is used to distribute a software key. Moreover, a way is provided to conveniently distribute keys to network devices wherein the potential for errors is substantially mitigated and convenience is substantially enhanced.

Generally, any of the methods or systems disclosed herein can be used in both home and business. Indeed, these items can typically be used in most small networks. As such, discussion of home use is by way of example only, and not by way of limitation. For example, home wiring can be defined herein to include business wiring.

Embodiments described above illustrate, but do not limit, the invention. It should also be understood that numerous modifications and variations are possible in accordance with the principles of the present invention. Accordingly, the scope of the invention is defined only by the following claims.

1. An apparatus for distributing keys among network devices, the apparatus comprising:
a solid state memory;
a key stored in the solid state memory; and
wherein the solid state memory is configured such that the key is not user modifiable.

2. The apparatus as recited in claim 1, wherein the key is stored in the solid state memory prior to the apparatus being provided to the user.

3. The apparatus as recited in claim 1, wherein the key is stored in the solid state memory by a manufacturer.

4. The apparatus as recited in claim 1, wherein the solid state memory comprises a read only memory.

5. The apparatus as recited in claim 1, wherein the solid state memory comprises a re-writable memory and the ability to re-write to the solid state memory is not enabled.

6. The apparatus as recited in claim 1, wherein the solid state memory comprises an electrically erasable programmable read only memory (EEPROM) and the ability to re-write to the solid state memory is not enabled.

7. The apparatus as recited in claim 1, further comprising a housing for the solid state memory, the housing being configured for use with a home electrical wiring station.

8. The apparatus as recited in claim 1, further comprising a housing for the solid state memory, the housing being generally configured in the shape of a key.

9. The apparatus as recited in claim 1, further comprising a switch configured to effect copying of the key from the apparatus to a network device.

10. The apparatus as recited in claim 1, further comprising a light configured to indicate when a key has been copied from the apparatus to a network device.

11. A system for facilitating communication of network information via home electrical wiring, the system comprising:
a station comprising a key interface for receiving a key from a solid state memory, the key enabling a network communication when it matches a key of the communication;
an apparatus for distributing keys among stations, the apparatus comprising:
a solid state memory;
a key stored in the solid state memory; and
wherein the solid state memory is configured such that the key is not user modifiable.

12. The station system as recited in claim 11, wherein the station further comprises a network circuit configured to communicate with a network device via Ethernet.

13. The station as recited in claim 11, wherein the station further comprises a power coupler configured to modulate and demodulate home electrical power with network communications.

14. A station for facilitating communication of network information via home electrical wiring, the station comprising three prongs configured to be received by an electrical receptacle.

15. The station as recited in claim 14, wherein a ground prong enhances a stability of a mechanical attachment of the station to the electrical receptacle and wherein the ground prong does not provide an electrical connection to circuitry within the station.

16. The station as recited in claim 14, wherein the ground prong is formed of a non-conductor.

17. The station as recited in claim 14, wherein the ground prong is formed of plastic.

18. A method for making an apparatus for distributing keys among network devices, the method comprising storing a key on a solid state memory such that the key is not user modifiable.

19. The method as recited in claim 18, wherein storing a key on a solid state memory such that the key is not user modifiable comprises:
storing the key on re-writable solid state memory; and
disabling an ability to modify the key on the solid state memory.

20. The method as recited in claim 18, wherein storing a key on a solid state memory such that the key is not user modifiable comprises:
storing the key on a EEPROM; and
disabling an ability to erase the EEPROM.

21. The method as recited in claim 18, wherein storing a key on a solid state memory such that the key is not user modifiable comprises storing the key on read only memory.

22. A method for distributing keys in a network, the method comprising:
providing an apparatus for distributing keys among network devices, the apparatus having a key stored thereon such that the key cannot be modified by a user:
connecting the apparatus to a network device;
copying the key from the solid state memory to the network device; and
repeating the connecting and copying acts for a plurality of network devices.

23. The method as recited in claim 22, wherein the network devices comprise stations.

24. The method as recited in claim 22, wherein the network device communicate among one another via home electrical wiring.

25. A speaker/station comprising:
a housing;
at least one speaker disposed at least partially within the housing;
prongs attached to the housing, the prongs being configured to be received within an electrical receptacle; and
a powerline interface disposed within the housing and in electrical communication with the speaker and the prongs.

26. The speaker/station as recited in claim 25, further comprising a key interface circuit disposed within the housing and configured so as to facilitate use of the power powerline interface only after a software key has been communicated to the key interface circuit.

27. The speaker/station as recited in claim 25, further comprising a keyhole formed in the housing so as to accept a hardware key.

28. The speaker/station as recited in claim 25, further comprising:
a keyhole formed in the housing so as to accept a hardware key; and
a key interface circuit disposed within the housing and configured so as to facilitate use of the power powerline interface only after a software key has been communicated to the key interface via insertion of a hardware key into the keyhole.

29. The speaker/station as recited in claim 25, wherein the prongs are configured so as to rotate in a manner that facilitates mounting of the speaker/station either horizontally or vertically.

30. The speaker/station as recited in claim 25, wherein the speakers comprise plural speakers having plural sizes.

31. A network adapter comprising:
at least one receptacle configured to communicate electrical power from home wiring; and
at least one network connector configured to communicate network information via home wiring.

32. The network adapter as recited in claim 31, wherein the network adapter is configured to replace a standard receptacle.

33. The network adapter as recited in claim 31, wherein the receptacles and the network connectors are at least partially contained within a common housing.

34. The network adapter as recited in claim 31, further comprising a powerline interface circuit disposed within the housing and configured to facilitate network communication between a network device connected to one of the network connectors and home wiring.

35. The network adapter as recited in claim 31, further comprising:
a powerline interface; and
a key interface circuit disposed within the housing and configured so as to facilitate use of the powerline interface only after a software key has been communicated to the powerline interface.

36. The network adapter as recited in claim 31, further comprising:
a housing;
a keyhole formed in the housing;
a powerline interface; and
a key interface circuit disposed within the housing and configured so as to facilitate use of the powerline interface only after a software key has been communicated to the powerline interface via insertion of a hardware key into the keyhole.
